(19) United States
(12) Patent Application Publication
(10) Pub. No.: US 2010/0017505 A1
(43) Pub. Date: Jan. 21, 2010

(54) APPLICATION UPDATING MANAGEMENT TERMINAL DEVICE, SYSTEM AND PROGRAM

(75) Inventors: Tomihisa Kamada, Tokyo (JP); Hiroyuki Suzuki, Yokohama (JP); Fumio Kawabata, Saitama (JP)

Correspondence Address: MORRISON & FOERSTER LLP, 425 MARKET STREET, SAN FRANCISCO, CA, 94105-2482, US

(73) Assignee: ACCESS CO., LTD., Chiyoda-ku, Tokyo (JP)

(21) Appl. No.: 12/519,750

(22) PCT Filed: Nov. 7, 2007
(86) PCT No.: PCT/JP2007/001224

§ 371 Date: Jun. 17, 2009

(30) Foreign Application Priority Data
Dec. 18, 2006 (JP) 2006-340178

(51) Int. Cl. G06F 9/44; G06F 15/177

(52) U.S. Cl. 709/221; 717/168

(57) ABSTRACT

A use frequency communicating unit 108 creates use frequency information for intra-terminal applications by referring to a record of the status of activation of the intra-terminal applications, and present the use frequency information for at least one of the intra-terminal applications. An information storage unit 112 stores substitute application information in association with each intra-terminal application, the substitute application information being related to a substitute application suggested to a user as a substitute when an intra-terminal application is deleted. An application deleting unit acknowledges a direction from the user requesting deletion of at least one of the intra-terminal applications for which the use frequency information is presented. A substitute application presenting unit 120 selects the substitute application information associated with the application subject to deletion, from the information storage unit 112, and present the selected substitute application information to the user.

### TECHNICAL FIELD

The present invention relates to a technology of organizing applications built in a terminal.

### BACKGROUND ART

Information terminals such as personal computers and cell phones available recently have a variety of default applications preinstalled in the terminal. However, users hardly use all of these applications. In such a case, it is desirable to check the use status of the applications and delete unnecessary applications. Generally, a memory area in a portable terminal is limited, and so the need to organize applications is particularly high.

For example, patent document No. 1 discloses a technology whereby a client device is requested to communicate the use state of a plurality of programs installed in the device. The program to be uninstalled is detected by referring to the use state communicated from the client device in response to the request. Patent document No. 2 discloses a technology whereby a function updating server for a cell phone is accessed to acquire a dedicated application program. When the memory capacity of a cell phone is running out, the user starts a function usage status referring unit and selects and deletes those of the registered functions that are no longer needed.

[patent document No. 1] JP 2005-44000
[patent document No. 2] JP 2005-236507

### DISCLOSURE OF THE INVENTION

### Problem to be Solved by the Invention

However, patent document No. 1 does not allow for the effective usage of a memory area released by deleting an application program. In patent document No. 2, deletion of a registered function is requested after determining the acquisition of a new application so that the user may not be able to identify a function that may be deleted.

The present invention addresses these disadvantages and a purpose thereof is to provide a technology of taking advantage of a memory area released when an application is deleted from a terminal.

### Means to Solve the Problem

One embodiment of the present invention relates to a terminal for managing the updating of applications. The terminal comprises: a use frequency communicating unit operative to create use frequency information for intra-terminal applications and present the use frequency information for at least one of the intra-terminal applications to a user; an information storage unit operative to store substitute application information in association with each intra-terminal application, the substitute application information being related to a substitute application suggested to a user as a substitute when an intra-terminal application is deleted; an application deleting unit operative to acknowledge a direction from the user requesting deletion of at least one of the intra-terminal applications for which the use frequency information is presented; and a substitute application presenting unit operative to select the substitute application information associated with the application subject to deletion, from the information storage unit, and present the selected substitute application information to the user.

According to this embodiment, substitute application information is stored for each intra-terminal application. When the user directs the deletion of an arbitrary application by referring to the use frequency information on the intra-terminal applications, associated substitute application information is presented to the user. By installing the substitute application information thus presented in the terminal, the memory area released by the deletion of the intra-terminal application can be effectively used. By presenting the substitute application information for the application to be positively suggested for use by the user, the chance of using that application is increased.

The use frequency communicating unit may present an intra-terminal application less frequently used than defined by a predetermined threshold as an application with a low use frequency, and the application deleting unit may acknowledge permission or non-permission from the user for deletion of the application with a low use frequency. In this way, the user need only determine whether to delete an intra-terminal application selected by the terminal as being not so frequently used. Therefore, determination can be made more easily than when the use frequency of the intra-terminal applications is merely presented. By suggesting to the user to positively delete the application not so frequently used from the terminal, the memory area of the terminal is more effectively used.

The information storage unit may store a program of a substitute application in association with the substitute application information. In this way, installation of the application program selected by the user as a substitution application can be immediately started.

The information storage unit may store a plurality of options of substitute application information in association with each intra-terminal application. This increases the flexibility for the user to select substitute applications.

The information storage unit may store a plurality of options of substitute application information for respective categories of applications, and the substitute application presenting unit may select the substitute application information from the options belonging to the same category as the application subject to deletion. The categories include the type of application, vendor supplying the application, and the type of file executable by the application. By suggesting to the user an application of the same category as the application subject to deletion, as a substitute application, the suggestion may play the role of advertisement whereby the user is made aware of a new application.

The information storage unit may store a plurality of options of substitute application information for respective functions of applications, and the substitute application presenting unit may select the substitute application information from the options having the same function as the application subject to deletion. The term “function” refers to a process executable by using an application. For example, a full-function word processor application is provided with a plurality of functions including text input function, graphic drawing function, table creation function, document summarizing function, and document configuration function. By suggesting to the user an application having the same function as the application subject to deletion, as a substitute application, the suggestion may play the role of advertisement whereby the user is made aware of a new application. Inadvertent deletion of an intra-terminal application may deprive the terminal of a particular function and make the terminal less useful. By presenting an application having the same function as the application subject to deletion and allowing that application to be installed, the likelihood of avoiding such a disadvantage is increased.

The information storage unit may map the functions provided by the intra-terminal applications into the substitute application information related to the applications that can achieve the respective functions, and store the information accordingly. The substitute application presenting unit may identify a relatively frequently used function from among those functions of the application subject to deletion, and select the substitute application information associated with the identified function. Where some of the functions of the intra-terminal application subject to deletion are not used but some are used, those applications specifically targeting the latter functions may be suggested as substitute applications. This will increase the opportunities for the user to use substitute applications or the terminal and will improve usability.

The substitute application presenting unit may select, for substitution of the intra-terminal application, the substitute application information mapped into the intra-terminal application other than the application subject to deletion. According to this approach, the presentation achieves the role of advertisement by presenting information related to an enhanced version of an intra-terminal application not subject to deletion, an application from the same supplier as the intra-terminal application, or an application sold by a vendor that is a competitor of the vendor of the intra-terminal application.

Optional combinations of the aforementioned constituting elements, and implementations of the invention in the form of methods, apparatuses, systems, recording mediums and computer programs may also be practiced as additional modes of the present invention.

### ADVANTAGE OF THE PRESENT INVENTION

According to the present invention, the memory area released when an application is deleted from a terminal can be effectively used.

### BRIEF DESCRIPTION OF THE DRAWINGS

FIG. 1 shows the overall configuration of a network system including a portable information device provided with an application updating management function according to the embodiment;

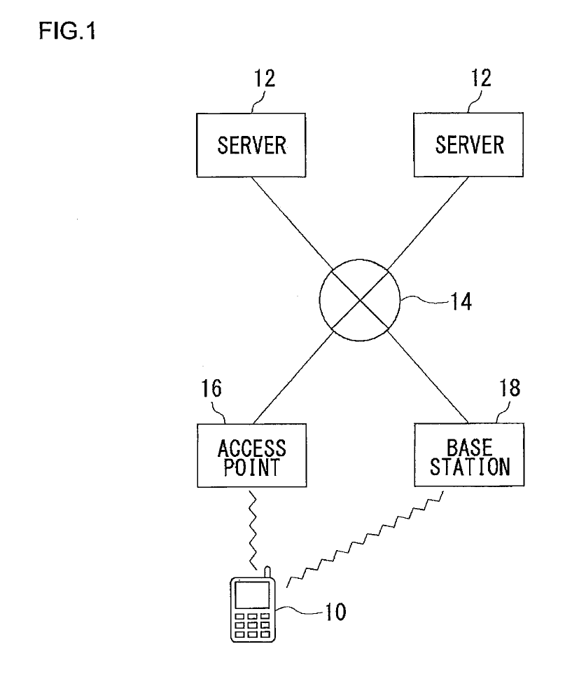

FIG. 2 shows the hardware configuration of the portable information device;

FIG. 3 shows the configuration of a part of the portable information device related to the application updating management function according to the first embodiment;

FIG. 4 shows a table storing exemplary use frequency information created by the use frequency communicating unit based on the record of activation status;

FIG. 5 shows a table storing exemplary substitute application information stored in the substitute application information storage unit;

FIG. 6 shows an exemplary menu screen displayed on a display screen of the portable information device;

FIG. 7 shows exemplary use frequency information displayed by the use frequency communicating unit on the display screen;

FIG. 8 shows, by way of example, how a request for confirmation is displayed after the user issues a direction to delete an intra-terminal application.

FIG. 9 shows, by way of example, how a suggestion for substitute applications is displayed after the intra-terminal application is deleted;

FIG. 10 is a flowchart of the process of presenting substitute application information according to the first embodiment;

FIG. 11 shows an exemplary screen illustrating the second embodiment;

FIG. 12 is a flowchart of the process of presenting substitute application information according to the second embodiment; and

FIG. 13 shows an exemplary screen illustrating the third embodiment.

10 portable information device, 12 server, 100 application updating management apparatus, 106 activation status storage unit, 108 use frequency communicating unit, 110 substitute application information requesting unit, 112 substitute application information storage unit, 118 application deleting unit, 120 substitute application presenting unit, 124 application adding unit, 126 program storage unit, 128 selection transmitting unit

### BEST MODE FOR CARRYING OUT THE INVENTION

### First Embodiment

One embodiment of the present invention relates to an application updating management apparatus, wherein the status of applications installed in a portable information device is monitored. Use frequency information of the applications is presented to a user by referring to the activation status. When an application subject to deletion is presented by the user, an application to be installed in place is suggested to the user.

A general explanation of the portable information device will be given first, followed by a detailed explanation of an application updating management apparatus according to the first embodiment.

A general explanation of the portable information device will be given first, followed by a detailed explanation of an application updating management apparatus according to the first embodiment.

The portable information device 10 may be any hardware movable with the user, such as a laptop PC (personal computer), PDA, cellular phone, and car navigation device provided with communication functions. The portable information device 10 is connected by the user's operation to a network 14, such as a LAN and the Internet, via an access point 16 or a base station 18, and is capable of accessing a server 12 specified by a URL and of acquiring desired data.

The server 12 provides the portable information device 10 with data such as text data, image data, audio data, video data, etc. via the network 14. The server may be a service entity on the Internet such as a web server. In that case, the invention may be implemented in various modes including: a mode embodied, for example, by a Common Gateway Interface (CGI) in which the server side takes care of the major processing functions; a mode embodied by, for example, a Java (registered trademark) applet in which the major processing functions are shifted to the client side; and a mode of Application Program Interface (API) type in which the main processing functions (e.g., Java applications) are distributed both to a server and a client.

The portable information device 10 is configured so that it can refer to and edit a file stored in an internal storage or a storage medium by the user's operation, even if the device does not access the network 14.

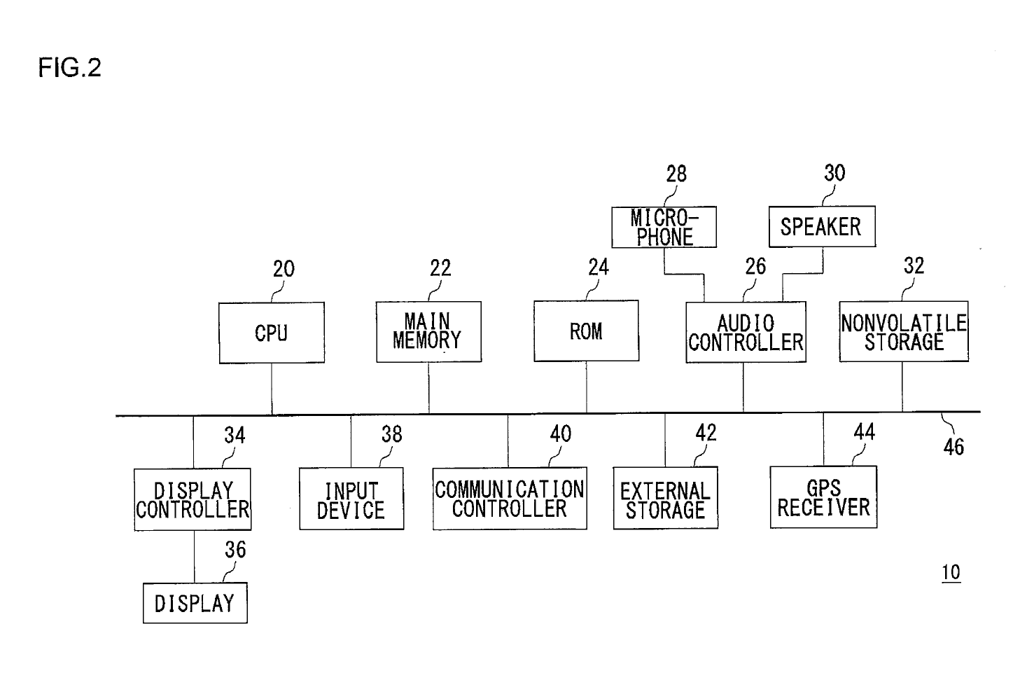

FIG. 2 shows the hardware configuration of the portable information device 10. The portable information device 10 is provided with a CPU 20, a main memory (RAM) 22, a ROM 24, an audio controller 26, a nonvolatile storage 32, a display controller 34, an input device 38, a communication controller 40, an external storage 42, and a GPS receiver 44. These are mutually connected via a bus 46.

The CPU 20 runs an operating system and controls the entire portable information device 10. The CPU 20 also reads into the main memory 22 a program and data from the ROM 24 or the recording medium loaded into the external storage 42, and performs various kinds of processing accordingly. The main memory 22 serves as a temporary storage and a work area which is needed when the CPU 20 executes the program, and as an area which stores various kinds of data required for program execution. The ROM 24 is a read-only storage which stores a computer program and data processed by the CPU 20.

The audio controller 26 is provided in the portable information device such as a cellular phone provided with a telephone function and is connected with a microphone 28 and a loudspeaker 30 for audio input output control.

The nonvolatile storage 32 is a storage capable of retaining the memory content even after power OFF, and may be a hard disk drive or a semiconductor memory such as a flash memory.

The display controller 34 generate a video signal for displaying the data drawn by the CPU in a frame buffer (not shown) on a display 36 provided in the portable information device 10.

The input device 38 is a device for the user to provide directions for operation to the portable information device 10. The input device 38 may be any device suited to the terminal. For example, the device may be: keys; a pointing device like a trackpad; buttons; and a touch panel provided on the surface of the display 36. A mouse may be connected to the portable information device via a universal serial bus (USB) terminal.

The communication controller 40 controls communication of sound and data by various communication schemes. The data communication scheme may be wireless LAN such as IEEE802.1b/g, infrared communication, or data communication such as packet communication. The portable information device 10 may be connected to the network 14 using a cable.

The external storage 42 is a drive device which uses a removable recording medium. The recording medium may be a magnetic disk, an optical disk, a magneto-optical disc, or a semiconductor memory.

The GPS receiver 44 is a device which locates the portable information device based on radio wave from a satellite.

Since the constituting elements described above are all well known, a description of further details will be omitted.

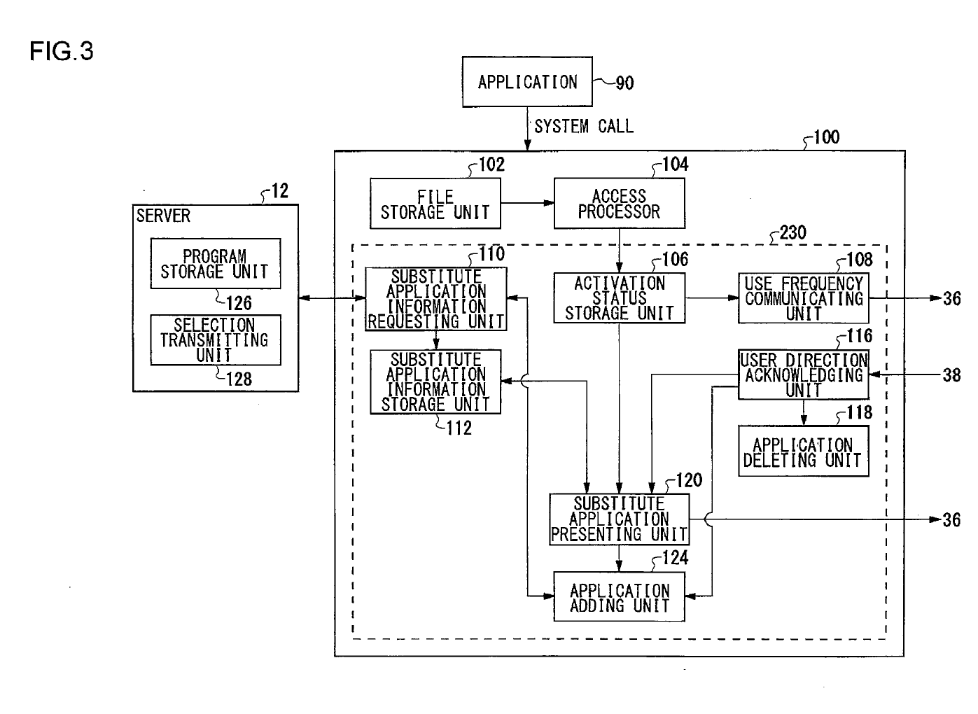

FIG. 3 shows the configuration of a part of the portable information device 10 related to the application updating management apparatus 100 according to the embodiment. The configuration is implemented in hardware by any CPU of a computer, a memory or other LSI's, and in software by a program or the like loaded into the memory. FIG. 3 depicts functional blocks implemented by the cooperation of hardware and software. Therefore, it will be obvious to those skilled in the art that the functional blocks may be implemented in a variety of manners including hardware only, software only, or a combination thereof.

Preferably, the application updating management apparatus 100 according to this embodiment is implemented by a part of an operating system. An operating system has various functions, such as process control, memory management, device management, and GUI. Of those functions implemented by the combination, FIG. 3 illustrates only those which pertain to this embodiment. The portion enclosed with the dashed line in FIG. 3 shows the functional block added to the operating system for realization of this embodiment. Those functions provided in a common operating system are of course provided even if they are not shown in FIG. 3.

Details of the operation and configuration of the functional blocks will now be described.

The file storage unit 102 holds a plurality of files read by various kinds of applications. For example, the file may be acquired via a network or stored in the storages 32 and 42 of the portable information device 10.

When a system call for file access is issued from any of a plurality of application programs 90 (hereinafter, referred to as intra-terminal application), the access processor 104 selects from the file storage unit 102 the file specified by the system call. The processor 104 then accesses the file designated by the system call. The file access process specified by a system call includes opening and closing, writing, deletion, etc. of a file. As a result of the file access process by the access processor 104, a screen showing the execution of the file by the application program is displayed on the display 36 of the portable information device 10.

An activation status storage unit 106 stores the state of activation of an intra-terminal application executed in the application processor 104 by referring to a system call for file access or file close from the intra-terminal application.

The use frequency communicating unit 108 creates use frequency information for each intra-terminal application by referring to the activation status stored in the activation status storage unit 106. The use frequency information includes the number of times that the intra-terminal application is activated (started), total use time, time elapsed since the last use, etc. The number of times of activation is known from the frequency of file accesses, which is one of the factors determining the activation status. By determining a total period of time required between file access and file close, the total period of time that each intra-terminal application is used is known. By examining the time that the file was closed last time and the current time, the time elapsed since the intra-terminal application was last used is known.

The use frequency communicating unit 108 monitors the use frequency of each intra-terminal application and communicates, responsive to a predetermined trigger, the use frequency information indicating the use frequency of some or all of the intra-terminal applications to the user. The unit 108 inquires whether the user wishes to delete any of the intra-terminal applications by referring to the use frequency information.

Various types of triggers may be employed. For example, the use frequency communicating unit 108 may communicate the use frequency information periodically. Alternatively, the use frequency information may be communicated when a particular screen is displayed in the portable information device 10 or a particular operation is made. The use frequency information may be communicated when the number of times of display of a menu screen or the number of times that the portable information device 10 is started reaches a predetermined value. Most preferably, the use frequency communicating 108 communicates the use frequency information for an intra-terminal application when the use frequency of any of the intra-terminal applications drops below a predetermined threshold value.

The use frequency communicating unit 108 may create the use frequency information for the intra-terminal applications using a scheme other than that based on the activation status. For example, the intra-terminal applications may be polled at predetermined intervals while the portable information device 10 is being started so that the use frequency is known by storing the history of responses.

A substitute application information storage unit 112 stores substitute application information related to a substitute application suggested to the user as a substitute when an intra-terminal application is deleted. The unit stores the information such that the information is mapped into each application. Preferably, the substitute application information storage unit 112 stores a plurality of items of optional substitute application information in association with each intra-terminal application. The substitute application information includes, for example, the name of a substitute application, location of storage of the substitute application, features of the substitute application, and comments for publicity or advertisement.

The substitute application information is stored in the substitute application information storage unit 112 in association with an intra-terminal application when the intra-terminal application is installed in the portable information device 10. Alternatively, the substitute application information may be stored in an external server 12 so that the information is acquired from the server periodically or triggered by some event.

When the user directs the deletion of an intra-terminal application for which the use frequency information is presented, a user direction acknowledging unit 116 acknowledges the direction. An application deleting unit 118 deletes the application in accordance with the direction.

A substitute application presenting unit 120 searches the substitute application information storage unit for substitute application information associated with the application directed by the user to be deleted. When there is a plurality of options of substitute application information, only one of the options may be selected or all of the options may be selected. The selected substitute application information is presented to the user and an inquiry is made as to whether to install the selected application in place of the application subject to deletion.

When the user selects a substitute application to be installed by referring to the substitute application information presented to the user, the user direction acknowledging unit 116 acknowledges the direction and notifies an application adding unit 124 accordingly. The application adding unit 124 requests the associated program from a substitute application information requesting unit 110.

The substitute application information requesting unit 110 requests the server 12 to transmit the program of the substitute application. The location of storage of the program is included in the substitute application information, as mentioned before. When the program is indicated as being stored at a local address of the portable information device 10, the substitute application information requesting unit 110 acquires the program by accessing the address.

The server 12 includes a program storage unit 126 and a selection transmitting unit 128. The program storage unit 126 stores the program of a substitute application in association with the substitute application information. The selection transmitting unit 128 retrieves the program of the substitute application selected by the user from the program storage unit 126 and transmits the program to the substitute application information requesting unit 110.

The substitute application information requesting unit 110 delivers the program of the substitute application received to the application adding unit 124. The application adding unit 124 installs the program thus received and places the substitute application in an executable state.

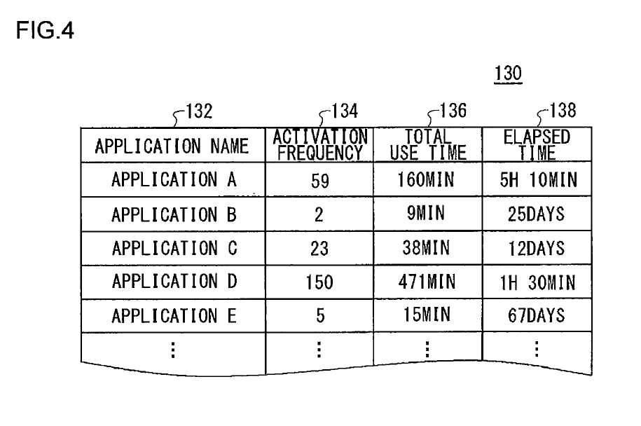

FIG. 4 shows a table 130 storing exemplary use frequency information created by the use frequency communicating unit 108 based on the record of activation status.

An application name column 132 lists names of the intra-terminal applications. FIG. 4 lists applications A through E. An activation frequency column 134 lists the number of times that the intra-terminal application is activated during a given period. A total use time column 136 lists the total time that each intra-terminal application is activated during a given period. An elapsed time column 138 lists the time elapsed since each intra-terminal application was last used until the time is totaled by the use frequency communicating unit 108. The “given period” indicates the time elapsed since the portable information device 10 was started to be used. The entry in the column 138 may indicate the time elapsed since the portable information device 10 was initialized or the time elapsed since the user erased the history of activation status.

FIG. 4 shows that applications B and E are characterized by the low activation frequency and less total use time and by the longer time elapsed since the last use when compared to applications A and D.

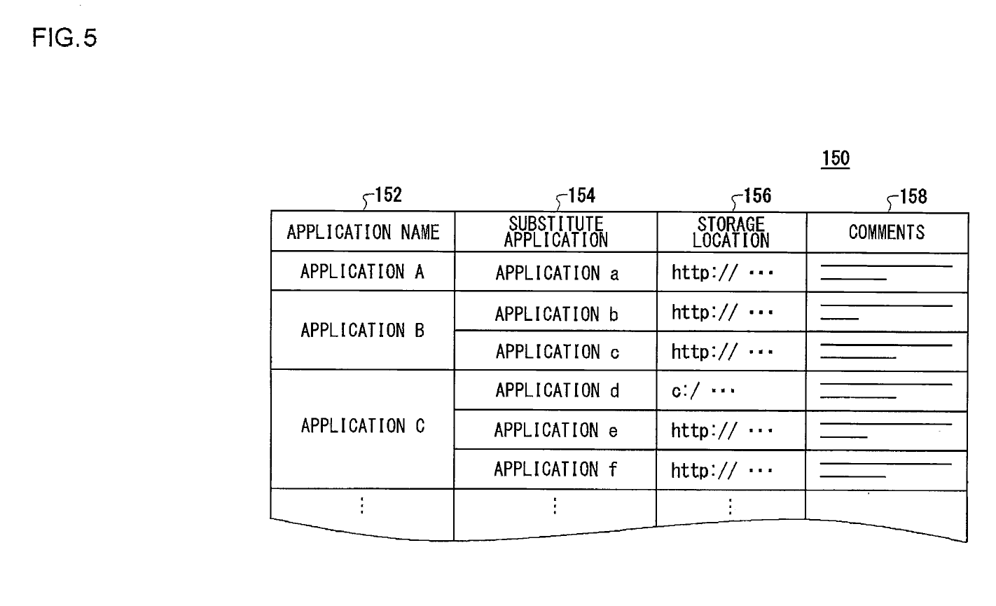

FIG. 5 shows a table 150 storing exemplary substitute application information stored in the substitute application information storage unit 112.

An application name column 152 lists the names of intra-terminal applications. FIG. 5 lists applications A through C. A substitute application column 154 lists the names of substitute applications suggested to the user as a substitute when the intra-terminal application is deleted. As shown, a plurality of substitute applications may be associated with an intra-terminal application.

A storage location column 156 lists the locations where the substitute applications in the column 154 are actually stored. In accordance with this information, the program is acquired by the substitute application information requesting unit 110. The storage location is indicated by a network address or a domain name designating the external server 12, etc. When the file size of an application program is not so large as compared to the storage capacity of the portable information device 10, the substitute application program may be stored in the portable information device 10 in advance. In this case, the storage location is indicated by a driver name or a path name. This is exemplified in FIG. 5 by the case of storage location for application d. The substitute application may be stored in a disk, etc. that comes with the portable information device 10.

A comment column 158 lists the character strings presented to the user as additional information when the substitute application is suggested to the user. The comment includes, for example, the type of a substitute application, functions of the application, features of the application, advertisement and other information. When the substitute application program is stored in an accessory disk, etc., the comment may indicate as such.

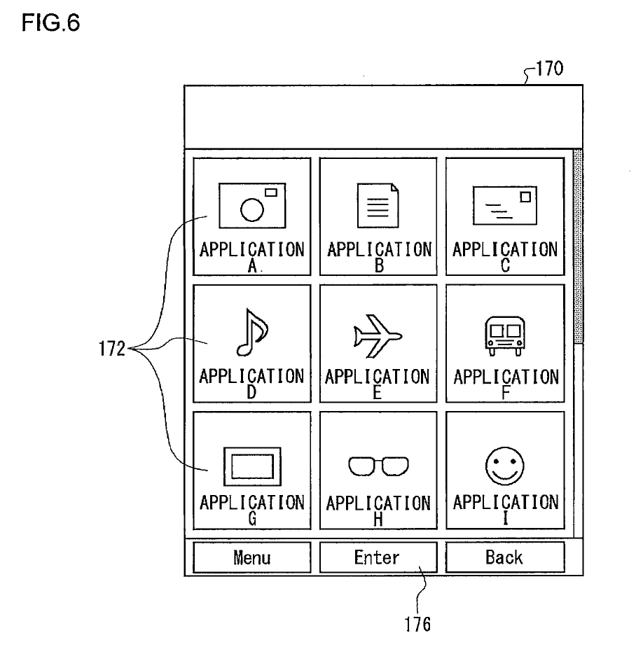

FIG. 6 shows an exemplary menu screen displayed on a display screen 170 of the portable information device 10. The menu screen shows icons 172 representing applications A through I, which are intra-terminal applications. When the user uses an input device such as a cross key (not shown) to select one of the icons and uses an Enter key 176, the corresponding intra-terminal application is activated.

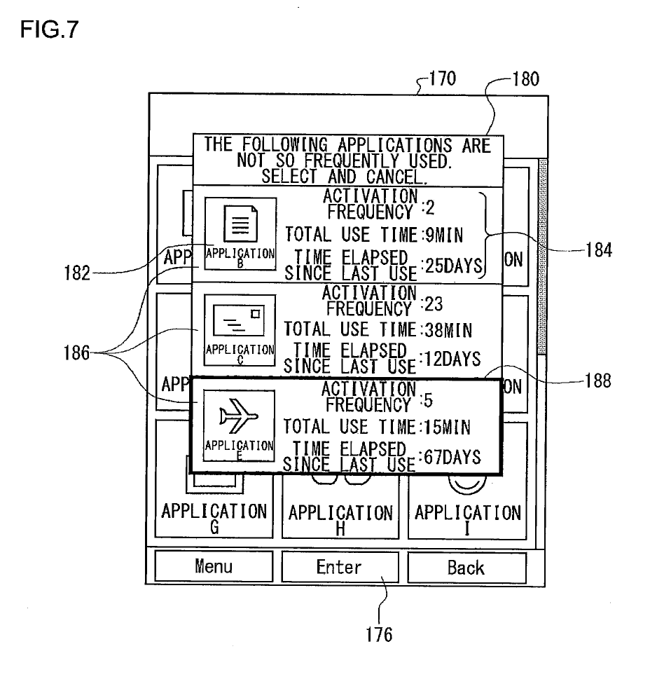

FIG. 7 shows exemplary use frequency information displayed by the use frequency communicating unit 108 on the display screen 170. FIG. 7 shows that the use frequency information is displayed in a window 180, which is superimposed on the menu screen. A text is displayed in the window 180, suggesting to the user that the intra-terminal application not so frequently used be deleted.

A column 186 for each intra-terminal application includes an icon 182 for the intra-terminal application and use frequency information 184. The user uses an input device (not shown) to move a focus 188 and select an application to be deleted.

In the example of FIG. 7, the use frequency communicating unit 108 selects an intra-terminal application used less frequently than defined by a predetermined threshold value as an application not so frequently used and presents the application as a candidate for deletion. The threshold value may be defined for the number of times of activation, for total use time, and for elapsed time, respectively. For example, applications activated ten times or less may be designated as candidates for deletion, applications used for a total of 60 minutes or shorter may be deletion candidates, and those with the elapsed time of 30 days or longer may be deletion candidates. The threshold value may be defined as a ratio with respect to the total number times that the intra-terminal applications in the portable information device 10 are activated or the total use time of the applications.

In a variation, the use frequency communicating unit 108 may display use frequency information for all intra-terminal applications irrespective of the use frequency. It is also favorable in this case to allow selected intra-terminal applications to be deleted according to the user selection. According to this variation, by displaying frequently used intra-terminal applications to compare them with other intra-terminal applications for use frequency, the user can determine whether the application is needed and may consider deleting an application if needed.

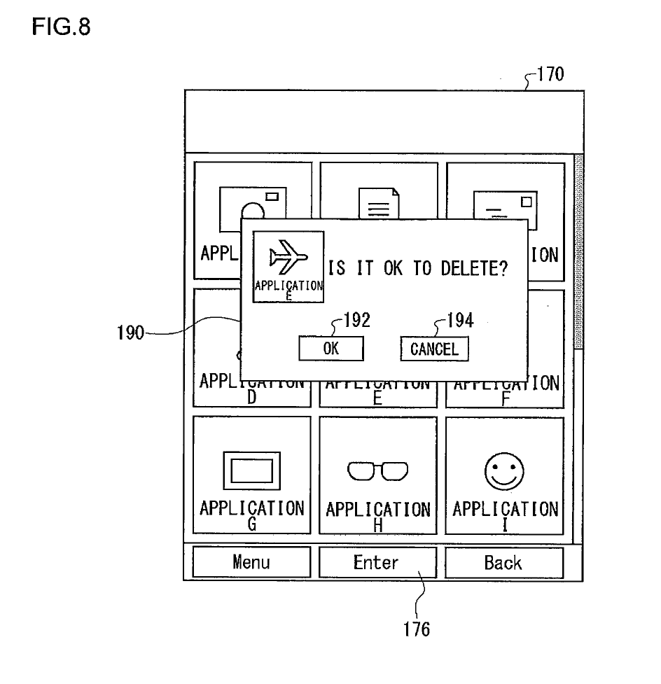

FIG. 8 shows, by way of example, how a request for confirmation is displayed after the user issues a direction to delete an intra-terminal application. Referring to FIG. 7, when the user selects, for example, the application E, the user direction acknowledging unit 116 acknowledges the user direction and displays a confirmation window 160. When an OK key 192 is selected, the application deletion unit 118 deletes the intra-terminal application. When a cancel key 194 is selected, the process is aborted.

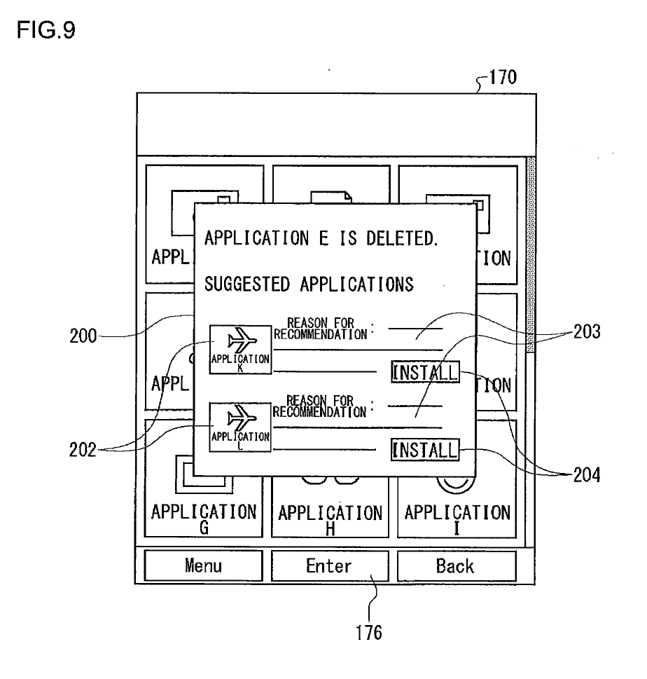

FIG. 9 shows, by way of example, how a suggestion for substitute applications is displayed after the intra-terminal application is deleted. When the application deletion unit 118 deletes the intra-terminal application, the substitute application presenting unit 120 retrieves substitute application information associated with the deleted application from the substitute application information storage unit 112 and displays the information in a window 200. The window 200 displays an icon 202 corresponding to the substitute application information, the application name, and, additionally, a comment 203 about the application. Selection of an install key 204 by the user directs the application adding unit 124 to install the corresponding substitute application.

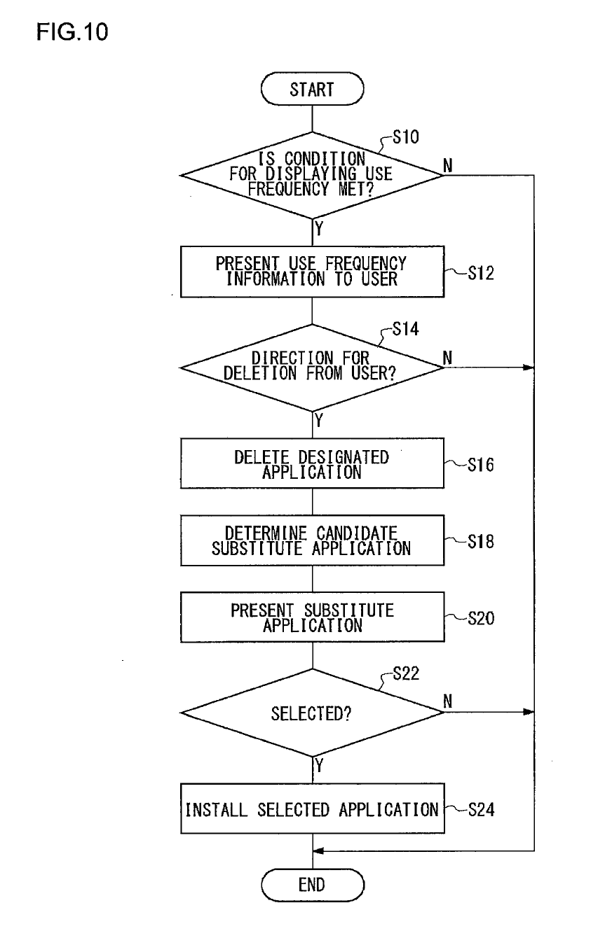

FIG. 10 is a flowchart of the process of presenting substitute application information according to the first embodiment.

The use frequency communicating unit 108 determines whether a predetermined condition that warrants presentation of use frequency information to the user is met (S10). If the condition is met (Y in S10), the use frequency communicating unit 108 presents the use frequency information for the intra-terminal application to the user (S12). The user direction acknowledging unit 116 waits for the user operation. If a direction to delete the intra-terminal application thus presented is not provided (N in S14), the process is terminated. If a direction for deletion is provided (Y in S14), the application deletion unit 118 deletes the intra-terminal application (S16).

The substitute application presenting unit 120 acquires the substitute application information associated with the intra-terminal application subject to deletion, from the substitute application information storage unit 112 (S18) and presents the information to the user (S20).

When the user provides a direction to install the presented substitute application (Y in S22), the application adding unit 124 acquires the substitute application and installs the application (S24). If the user does not provide a direction for installation (N in S22), the process is terminated.

### Second Embodiment

In the example of FIG. 9, the substitute application presenting unit 120 suggests substitute applications after the intra-terminal application selected by the user is deleted. Instead of this approach, substitute applications may be suggested before deleting an intra-terminal application.

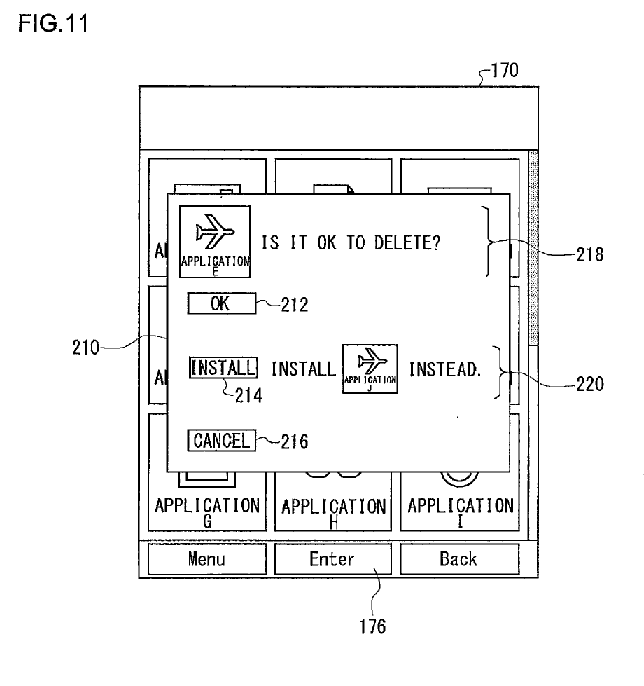

FIG. 11 shows an exemplary screen illustrating the second embodiment. When an application subject to deletion is selected by the user in the screen of FIG. 7, the substitute application presenting unit 120 displays a window 210. Inside the window 210, a message 218 requesting confirmation of whether the selected intra-terminal application may be deleted, and substitute application information 220 for the application suggested for replacement. When the user selects an “OK” key 212, the application deletion unit 118 deletes the intra-terminal application. When the user selects an “Install” key 214, the application deletion unit 118 deletes the intra-terminal application and the application adding unit 124 installs the substitute application. When the user selects a “Cancel” key 216, the process is terminated.

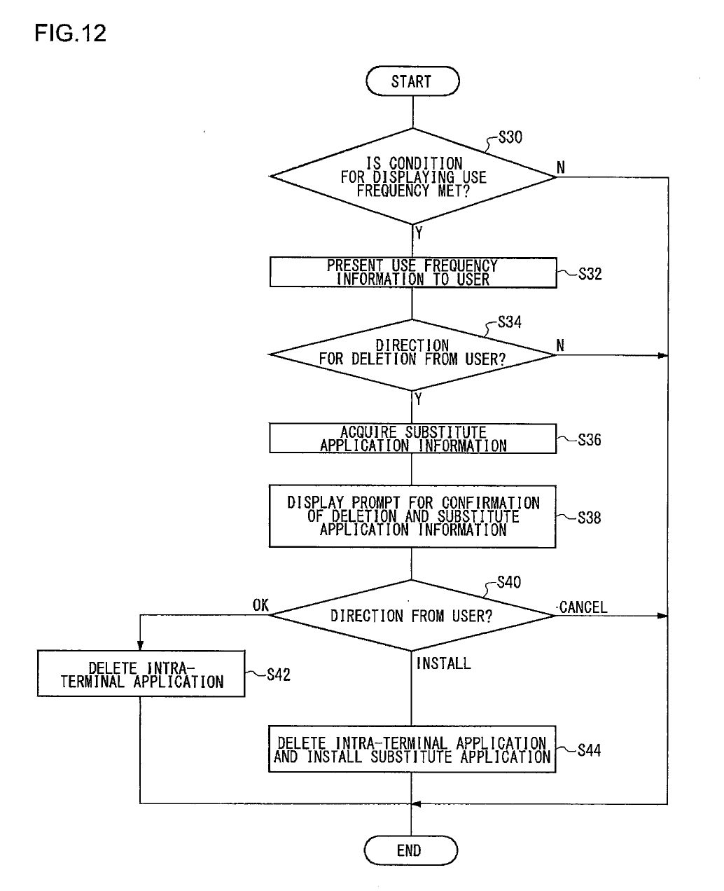

FIG. 12 is a flowchart of the process of presenting substitute application information according to the second embodiment.

The use frequency communicating unit 108 determines whether a predetermined condition that warrants presentation of use frequency information to the user is met (S30). If the condition is met (Y in S30), the use frequency communicating unit 108 presents the use frequency information for the intra-terminal application to the user (S32). The user direction acknowledging unit 116 waits for the user operation. If a direction to delete the intra-terminal application thus presented is not provided (N in S34), the process is terminated. If the user provides a direction for deletion (Y in S34), the substitute application presenting unit 120 acquires the substitute application information associated with the intra-terminal application subject to deletion, from the substitute application information storage unit 112 (S36) and presents the substitute application information to the user along with a message requesting confirmation of the deletion (S38). The direction from the user is acknowledged in S40. If “OK”, the application deletion unit 118 deletes the intra-terminal application subject to deletion (S42). If “Install” is selected, the intra-terminal application is deleted and the application adding unit 124 acquires and installs the substitute application (S44). If “Cancel” is selected, the process is terminated.

### Third Embodiment

The use frequency communicating unit 108 may select an intra-terminal application to be suggested to the user for deletion, based on the use frequency, and the user direction acknowledging unit 116 may acknowledge permission or non-permission from the user. In other words, the use frequency communicating unit 108 does not explicitly present the use frequency information to the user as in the first and second embodiments. Instead, the unit 108 selects an intra-terminal application not so frequently used and presents the application to the user.

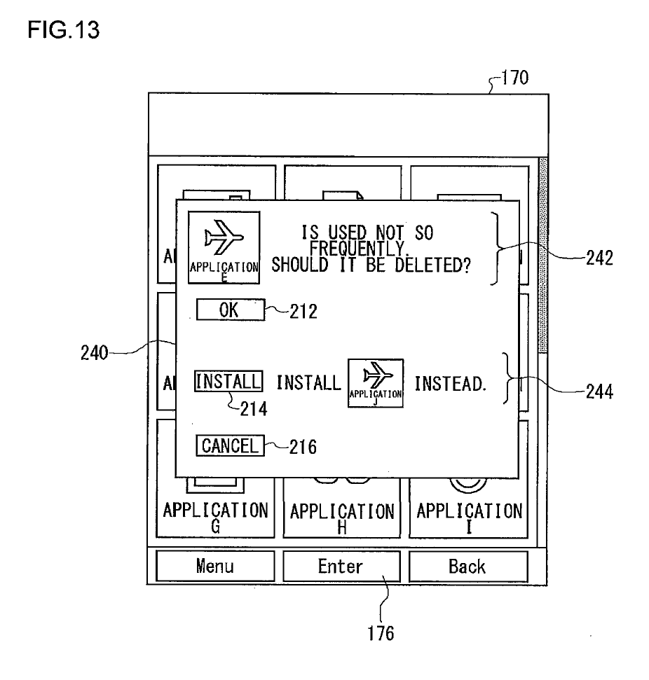

FIG. 13 shows an exemplary screen illustrating the third embodiment. The use frequency communicating unit 108 responds to a predetermined trigger, selects an intra-terminal application with a low use frequency as a candidate for deletion, and sends the selection to the substitute application presenting unit 120. The substitute application presenting unit 120 selects the substitute application information corresponding to the candidate intra-terminal application from the substitute application information storage unit 112. Subsequently, the substitute application presenting unit 120 displays a window 240. Inside the window 240, a message 242 requesting confirmation of whether the intra-terminal application selected by the use frequency communicating unit 108 as a candidate for deletion may be deleted, and substitute application information 244 for the application suggested for replacement. The roles of the “OK” key 212, “Install” key 214, and “Cancel” key 216 are the same as in the case of FIG. 11.

As described above, according to the embodiments, substitute application information is stored in association with each intra-terminal application. When the user directs deletion of an arbitrary application by referring to the use frequency information for the intra-terminal applications, the associated substitute application information is presented to the user. By installing the presented substitute application information in the terminal, the memory area released by the deletion of the intra-terminal application is effectively utilized.

Described above is an explanation based on an exemplary embodiment. The embodiment is intended to be illustrative only and it will be obvious to those skilled in the art that various modifications to constituting elements and processes could be developed and that such modifications are also within the scope of the present invention.

The substitute application information may be categorized and stored in the substitute application information storage unit 112. The applications may be grouped into ordinary categories including, but not limited to, word processors, spread sheets, mailing software, browsers, schedulers, photo retouching software, music players, etc.

In this case, the substitution application presenting unit 120 refers to the version information or the extension of the application subject to deletion and acquires information indicative of which category the application to be deleted is grouped. Subsequently, the unit 120 retrieves the substitute application information included in the same category as the application to be deleted and presents the information to the user.

The categories may be organized in a hierarchy where subcategories are provided in a category. For example, the substitute applications within a category may be subcategorized into full-function software and limited-function software and the substitute application information is stored accordingly. Alternatively, the substitute application information may be stored by grouping the applications according to subcategories defined for respective file types that can be handled by the substitute application. When there are a plurality of subcategories in a category, the substitute application presenting unit 120 may display the substitute application information belonging to the same subcategory as the application subject to deletion toward the top of the list, and display the substitute application information belonging to the same category but belonging to a different subcategory toward the bottom of the list.

The name of the vendor supplying the application may be used as a category so that the substitute application information may be stored in the respective categories. Once the application subject to deletion is determined, the substitute application presenting unit 120 refers to, for example, the version information for the application so as to identify the name of the vendor supplying the application. Subsequently, the unit 120 retrieves the substitute application information grouped into the same vendor category as the application subject to deletion from the substitute application information storage unit 112 and presents the information to the user.

By suggesting to the user the application of the same category as the application subject to deletion as a substitute application, the user is made aware of a new application. By presenting the substitute application information for the application to be positively suggested for use by the user, the chance of using that application is increased.

The substitute application information may be categorized according to the function and stored in the substitute application information storage unit 112. The substitute application information storage unit 112 may map the functions provided by the intra-terminal applications into the substitute application information related to the applications that can achieve the respective functions, and may store the information accordingly. When the intra-terminal application subject to deletion has a plurality of functions, the substitute application presenting unit 120 identifies the relatively frequently used function from among those functions of the application that are not the cause of the deletion. The unit 120 retrieves the substitute application information associated with the identified function from the substitute application information storage unit 112.

Where some of the functions of the intra-terminal application subject to deletion are not used but some are used, those applications specifically targeting the latter functions are suggested as substitute applications. Therefore, the user is given more opportunities to use the substitute application or the terminal.

Further, the substitute application presenting unit 120 may select the substitute application information mapped into the intra-terminal application other than the application subject to deletion. For example, the unit 120 may present information related to an enhanced version or a successor to a relatively frequently used intra-terminal application, an application functioning in coordination with the intra-terminal application, an application from the same supplier as the intra-terminal application, or an application sold by a vendor that is a competitor of the vendor of the intra-terminal application. In this way, presentation of a substitute application may play the role of advertisement.

In the embodiments as described, when a direction to delete an application is provided by the user, substitute application information is presented to the user along with a warning requesting for confirmation of deletion.

Alternatively, the substitute application presenting unit 120 may present substitute application information at a different point of time. For example, substitute application information may be presented to the user along with or built in a screen that the user simply watches while the screen is being displayed without performing any operation. Examples of such a screen include a start-up screen, a screen displayed while an email message is being transmitted, a screen displayed while the terminal is communicating with a server, and a screen displayed while data is being saved.

In the embodiments as described, the application selected by the user is deleted from the portable information device 10. Alternatively, the selected application may be compressed or transferred to a server.

Right to be presented as a substitute application substituting an intra-terminal application may be sold. For example, given that a word processor application is installed in the portable information device 10, another word processor application may be presented as the substitute application information. In this way, presentation of substitute application information may be used as an opportunity for advertisement of an application that competes with the installed application. In this case, the substitute application information may be presented when the use frequency of the intra-terminal application is higher than a predetermined threshold value.

In the embodiments as described, the substitute application information is stored in the substitute application information 112 in the portable information device 10. Alternatively, the substitute application information may be acquired from a server.

In this case, when the user direction acknowledging unit acknowledges a direction to delete an intra-terminal application from the user, the substitute application information requesting unit transmits the name of the intra-terminal application subject to deletion to the server and requests the corresponding substitute application information from the server.

The substitute application information storage unit provided in the server stores the substitute application information in association with the respective intra-terminal applications. The selection transmitting unit at the server side responds to the request from portable information device 10 and retrieves from the substitute application information storage unit the substitute application information associated with the intra-terminal application subject to deletion and transmits the information thus retrieved to the device. The substitute application presenting unit at the side of the portable information device 10 presents the substitute application information received from the server to the user.

Alternatively, the substitute application information requesting unit may request the substitute application information corresponding to the intra-terminal application from the server, before the use information communicating unit presents the use frequency of the intra-terminal application to the user.

By providing the substitute information storage unit in the server, the substitute application information can be updated and added at the server side at any desired time, allowing the latest information to be presented to the user of the portable information device.

In this case, the substitute application information adapted to the type of the portable information device may be selected at the server side. In other words, the substitute application information storage unit at the server side stores, in association with each item of substitute application information, the identification information (ID) of the portable information device capable of executing the substitute application. When requesting substitute application information, the substitute application information requesting unit transmits the identification information identifying the type of the portable information device to the server. The selection transmitting unit at the server side receives the identification information from the portable information device and selects the substitute application information adapted to the type. In this way, proper substitute application information can be acquired even when the types of preinstalled intra-terminal applications differ from one type of portable information device to another, or even when the types of executable applications differ from one device type to another.

In the embodiments, the information display unit according to the present invention is described as being implemented in a portable information device such as a cell phone, a PDA, a vehicle navigation device, etc. provided with data communication functions. The inventive apparatus may of course be implemented in desktop hardware such as a desktop PC.

### INDUSTRIAL APPLICABILITY

According to the present invention, the memory area released when an application is deleted from a terminal can be positively used.

1. An application updating management terminal for managing the updating of applications, comprising:
a use frequency communicating unit operative to create use frequency information for intra-terminal applications and present the use frequency information for at least one of the intra-terminal applications to a user;
an information storage unit operative to store substitute application information in association with at least one of the intra-terminal applications, the substitute application information being related to a substitute application suggested to a user as a substitute when an intra-terminal application is deleted;
an application deleting unit operative to acknowledge a direction from the user requesting deletion of at least one of the intra-terminal applications for which the use frequency information is presented; and
a substitute application presenting unit operative to select the substitute application information associated with the application subject to deletion, from the information storage unit, and present the selected substitute application information to the user.

2. The application updating management terminal according to claim 1, wherein
the use frequency communicating unit presents an intra-terminal application less frequently used than defined by a predetermined threshold as an application with a low use frequency, and the application deleting unit acknowledges permission or non-permission from the user for deletion of the application with a low use frequency.

3. The application updating management terminal according to claim 1, wherein
the information storage unit stores a program of a substitute application in association with the substitute application information.

4. The application updating management terminal according to claim 1, wherein
the information storage unit stores a plurality of options of substitute application information in association with each intra-terminal application.

5. The application updating management terminal according to claim 4, wherein
the information storage unit stores a plurality of options of substitute application information for respective categories of applications, and
the substitute application presenting unit selects the substitute application information from the options belonging to the same category as the application subject to deletion.

6. The application updating management terminal according to claim 4, wherein
the information storage unit stores a plurality of options of substitute application information for respective functions of applications, and
the substitute application presenting unit selects the substitute application information from the options having the same function as the application subject to deletion.

7. The application updating management terminal according to claim 6, wherein
the information storage unit maps the functions provided by the intra-terminal applications into the substitute application information related to the applications that can achieve the respective functions, and stores the information accordingly,
the substitute application presenting unit identifies a relatively frequently used function from among those functions of the application subject to deletion, and selects the substitute application information associated with the identified function.

8. The application updating management terminal according to claim 1, wherein
the substitute application presenting unit selects, for substitution of the intra-terminal application, the substitute application information mapped into the intra-terminal application other than the application subject to deletion.

9. An application updating management computer product comprising program code executable in a terminal and embodied on a computer-readable storage medium, the program code comprising:
a use frequency information communicating module that creates use frequency information for intra-terminal applications, and presents the use frequency information for at least one of the intra-terminal applications to a user;
an information storage module that stores substitute application information in association with at least one of the intra-terminal applications, the substitute application information being related to a substitute application suggested to a user as a substitute when an intra-terminal application is deleted;
an application deleting module that acknowledges a direction from the user requesting deletion of at least one of the intra-terminal applications for which the use frequency information is presented; and
a substitute application presenting module that selects the substitute application information associated with the application subject to deletion, and presents the selected substitute application information to the user.

10. A server-client system for managing the updating of applications in a terminal, comprising a client and a server,
the client comprising:
a use frequency communicating unit operative to create use frequency information for intra-terminal applications and present the use frequency information for at least one of the intra-terminal applications to a user;
an information storage unit operative to store substitute application information in association with at least one of the intra-terminal applications, the substitute application information being related to a substitute application suggested to a user as a substitute when an intra-terminal application is deleted;
an application deleting unit operative to acknowledge a direction from the user requesting deletion of at least one of the intra-terminal applications for which the use frequency information is presented; and
a substitute application presenting unit operative to select the substitute application information associated with the application subject to deletion, from the information storage unit, and present the selected substitute application information to the user,
an information requesting unit operative to request the server to provide a program of the substitute application corresponding to the substitute application information presented to the user,
the server comprising:
a program storage unit operative to store a program of a substitute application in association with the substitute application information; and
a selection transmitting unit operative to select the program responsive to the request from the terminal and to transmit the selected program.

11. A server-client system for managing the updating of applications in a terminal, comprising a client and a server,
a use frequency communicating unit operative to create use frequency information for intra-terminal applications and present the use frequency information for at least one of the intra-terminal applications to a user;
an application deleting unit operative to acknowledge a direction to delete at least one of the intra-terminal applications for which the use frequency information is presented;
an information requesting unit operative to request the server to provide the substitute application information related to the substitute application suggested to the user as a substitute for the application subject to deletion; and
a substitute application presenting unit operative to present the substitute application information received from the server in response to the request,
the server comprising:
an information storage unit operative to store the substitute application information in association with at least one of the intra-terminal applications; and
a selection transmitting unit operative to select the substitute application information associated with the application subject to deletion, from the information storage unit, and transmit the selected information to the terminal, in response to the request.

12. The server-client system according to claim 11, wherein
when requesting substitute application information, the information requesting unit transmits identification information identifying the type of the terminal to the server,
the information storage unit stores, in association with each item of substitute application information, the identification information of the terminal capable of executing the substitute application, and
the selection transmitting unit receives the identification information from the terminal and selects the substitute application information adapted to the terminal.

13. The application updating management computer product according to claim 9, wherein
the use frequency communicating module presents an intra-terminal application less frequently used than defined by a predetermined threshold as an application with a low use frequency, and the application deleting module acknowledges permission or non-permission from the user for deletion of the application with a low use frequency.

14. The application updating management computer product according to claim 9, wherein
the information storage module stores a program of a substitute application in association with the substitute application information.

15. The application updating management computer product according to claim 9, wherein
the information storage module stores a plurality of options of substitute application information in association with each intra-terminal application.

16. The application updating management computer product according to claim 15, wherein
the information storage module stores a plurality of options of substitute application information for respective categories of applications, and
the substitute application presenting module selects the substitute application information from the options belonging to the same category as the application subject to deletion.

17. The application updating management computer product according to claim 15, wherein
the information storage module stores a plurality of options of substitute application information for respective functions of applications, and
the substitute application presenting module selects the substitute application information from the options having the same function as the application subject to deletion.

18. The application updating management computer product according to claim 17, wherein
the information storage module maps the functions provided by the intra-terminal applications into the substitute application information related to the applications that can achieve the respective functions, and stores the information accordingly,
the substitute application presenting module identifies a relatively frequently used function from among those functions of the application subject to deletion, and selects the substitute application information associated with the identified function.

19. The application updating management computer product according to claim 9, wherein
the substitute application presenting module selects, for substitution of the intra-terminal application, the substitute application information mapped into the intra-terminal application other than the application subject to deletion.

20. The server-client system according to claim 10, wherein
the use frequency communicating unit presents an intra-terminal application less frequently used than defined by a predetermined threshold as an application with a low use frequency, and the application deleting unit acknowledges permission or non-permission from the user for deletion of the application with a low use frequency.

21. The server-client system according to claim 10, wherein
the information storage unit stores a program of a substitute application in association with the substitute application information.

22. The server-client system according to claim 10, wherein
the information storage unit stores a plurality of options of substitute application information in association with each intra-terminal application.

23. The server-client system according to claim 22, wherein
the information storage unit stores a plurality of options of substitute application information for respective categories of applications, and
the substitute application presenting unit selects the substitute application information from the options belonging to the same category as the application subject to deletion.

24. The server-client system according to claim 22, wherein
the information storage unit stores a plurality of options of substitute application information for respective functions of applications, and
the substitute application presenting unit selects the substitute application information from the options having the same function as the application subject to deletion.

25. The server-client system according to claim 24, wherein
the information storage unit maps the functions provided by the intra-terminal applications into the substitute application information related to the applications that can achieve the respective functions, and stores the information accordingly,
the substitute application presenting unit identifies a relatively frequently used function from among those functions of the application subject to deletion, and selects the substitute application information associated with the identified function.

26. The server-client system according to claim 10, wherein
the substitute application presenting unit selects, for substitution of the intra-terminal application, the substitute application information mapped into the intra-terminal application other than the application subject to deletion.

27. The server-client system according to claim 11, wherein
the use frequency communicating unit presents an intra-terminal application less frequently used than defined by a predetermined threshold as an application with a low use frequency, and the application deleting unit acknowledges permission or non-permission from the user for deletion of the application with a low use frequency.

28. The server-client system according to claim 11, wherein
the information storage unit stores a program of a substitute application in association with the substitute application information.

29. The server-client system according to claim 11, wherein
the information storage unit stores a plurality of options of substitute application information in association with each intra-terminal application.

30. The server-client system according to claim 29, wherein
the information storage unit stores a plurality of options of substitute application information for respective categories of applications, and
the substitute application presenting unit selects the substitute application information from the options belonging to the same category as the application subject to deletion.

31. The server-client system according to claim 29, wherein
the information storage unit stores a plurality of options of substitute application information for respective functions of applications, and
the substitute application presenting unit selects the substitute application information from the options having the same function as the application subject to deletion.

32. The server-client system according to claim 31, wherein
the information storage unit maps the functions provided by the intra-terminal applications into the substitute application information related to the applications that can achieve the respective functions, and stores the information accordingly,
the substitute application presenting unit identifies a relatively frequently used function from among those functions of the application subject to deletion, and selects the substitute application information associated with the identified function.

33. The server-client system according to claim 11, wherein
the substitute application presenting unit selects, for substitution of the intra-terminal application, the substitute application information mapped into the intra-terminal application other than the application subject to deletion.
